(19) United States
(12) Patent Application Publication
(10) Pub. No.: US 2026/0294075 A1
(43) Pub. Date: Oct. 1, 2026

(54) COSMETIC APPLICATOR

(71) Applicant: MITSUBISHI PENCIL COMPANY, LIMITED, Tokyo (JP)

(72) Inventors: Kota FUJIMOTO, Fujioka-shi, Gunma (JP); Yusuke NAKAMURA, Fujioka-shi, Gunma (JP)

(73) Assignee: MITSUBISHI PENCIL COMPANY, LIMITED, Tokyo (JP)

(21) Appl. No.: 18/880,554

(22) PCT Filed: Jul. 24, 2023
(86) PCT No.: PCT/JP2023/026937

§ 371 Date: Jan. 1, 2025

(30) Foreign Application Priority Data
Aug. 1, 2022 (JP) 2022-122821
Dec. 8, 2022 (JP) 2022-196522

(51) Int. Cl. A45D 34/04

(52) U.S. Cl. CPC A45D 34/042; A45D 2200/1072

(57) ABSTRACT

Provided is a cosmetic applicator by which it is possible to secure liquid supply to an applicator during upward drawing/drawing after upward storage, and to secure a drawing performance. The cosmetic applicator includes a collector core that guides a cosmetic liquid from a cosmetic liquid tank to an application portion, a collector that temporarily retains the cosmetic liquid, the collector being penetrated by the collector core, and a cosmetic liquid holding portion provided in the collector. The cosmetic liquid holding portion is formed with a space holding the cosmetic liquid, and the cosmetic liquid held in the cosmetic liquid holding portion contacts the collector core.

### TECHNICAL FIELD

The present invention relates to a cosmetic applicator containing a cosmetic liquid.

### BACKGROUND ART

In eyeliners for low-viscosity cosmetic liquids using a collector of the related art, the cosmetic liquid moves to a lower side of an ink tank when an application portion such as a brush tip is turned upward. Therefore, fading may occur during upward drawing or the brush may dry during storage. Patent Documents 1 to 3 disclose cosmetic applicators in which an ink retaining body is provided at a rear end portion of a collector.

### CITATION LIST

### Patent Document

Patent Document 1: JP 2018-126873 A
Patent Document 2: JP 2004-98318 A
Patent Document 3: JP 2002-225489 A

### SUMMARY OF INVENTION

### Technical Problem

However, in Patent Documents 1 to 3, the ink retaining body is formed of a member such as a porous body. Therefore, the supply of the cosmetic liquid to the collector core (relay core) may be hindered, and thus, there is room for improvement.

In view of the above-described circumstances, an object of the present invention is to provide a cosmetic applicator by which it is possible to secure liquid supply to an applicator during upward drawing/drawing after upward storage, to secure a drawing performance.

### Solution to Problem

In the present invention, to solve the above-described problems, a collector includes a cosmetic liquid holding portion as a space capable of retaining a cosmetic liquid even in an upward stationary state. The cosmetic liquid holding portion holds a constant amount of cosmetic liquid and thus, it is possible to supply the cosmetic liquid to a collector core (relay core) even in the upward state.

Specifically, the present invention is a cosmetic applicator including a collector core that guides a cosmetic liquid from a liquid storage portion to an application portion, a collector that temporarily retains the cosmetic liquid, the collector being penetrated by the collector core, and a cosmetic liquid holding portion provided in the collector, and in the cosmetic applicator, the cosmetic liquid holding portion is formed with a space holding the cosmetic liquid, and the cosmetic liquid held in the cosmetic liquid holding portion contacts the collector core.

In the present invention, it is preferable that the cosmetic liquid holding portion includes a space formed as a recess in a cross-sectional view, and the space formed as a recess in a cross-sectional view holds the cosmetic liquid, is formed in a rear portion of the collector, and contacts the collector core.

In the present invention, it is preferable that the cosmetic liquid holding portion holds the cosmetic liquid in a space between sheet bodies provided at a front portion or a center portion of the collector, and the space between the sheet bodies contacts the collector core.

In the present invention, it is preferable that the cosmetic liquid holding portion is integrally formed with the collector.

Furthermore, the amount of cosmetic liquid held in the cosmetic liquid holding portion is preferably 20 to 40 mg. The amount of cosmetic liquid held in the cosmetic liquid holding portion may be determined by subtracting the weight of the product when fading occurs during upward drawing, from the weight of the product before drawing in a state where the cosmetic liquid holding portion is filled with the cosmetic liquid.

### Advantageous Effects of Invention

According to the applicator of the present invention, it is possible to achieve an excellent effect which is an ability of securing liquid supply to the applicator during upward drawing/drawing after upward storage to secure a drawing performance.

### BRIEF DESCRIPTION OF DRAWINGS

FIG. 1 is an explanatory diagram of a cosmetic applicator according to a first embodiment of the present invention with a cap on, in which (a) is a side view, (b) is an overall vertical cross-sectional view, and (c) is an overall vertical cross-sectional view rotated by 90 degrees in a circumferential direction from (b).

FIG. 2 is an explanatory diagram of the cosmetic applicator of FIG. 1 in a state where the cap is removed and the cosmetic applicator is directed upward, in which (a) is an overall vertical cross-sectional view and (b) is an enlarged view of a collector in the same state and the vicinity of the collector.

FIG. 3 is a component diagram of the collector in the cosmetic applicator of FIG. 1, in which (a) is a perspective view from the front, (b) is a view from the front, (c) is a side view from a side of a slit, (d) is a side view rotated by 90 degrees in the circumferential direction from (c), (e) is a vertical cross-sectional view taken along line E-E in (c), (f) is a perspective view from the rear, and (g) is a view from the rear.

FIG. 4 is perspective view of the cosmetic applicator in FIG. 1, illustrating a quarter cutaway view of a part from an application portion to a front barrel.

FIG. 5 illustrates evaluation results of Examples 1 to 3 in a forced fading test.

FIG. 6 illustrates evaluation results of Comparative Examples 1 to 3 in a forced fading test.

FIG. 7 is a component diagram of a collector in a cosmetic applicator according to a second embodiment, in which (a) is a perspective view from the front, (b) is a view from the front, (c) is a side view from a side of a slit, (d) is a side view rotated by 90 degrees in the circumferential direction from (c), (e) is a vertical cross-sectional view taken along line E-E in (c), (f) is a perspective view from the rear, (g) is a view from the rear, and (h) is a transverse section taken along line H-H of (d).

FIG. 8 is perspective view of the cosmetic applicator according to the second embodiment, illustrating a quarter cutaway view of a part from an application portion to a front barrel.

FIG. 9 is a component diagram of a collector in a cosmetic applicator according to a third embodiment, in which (a) is a perspective view from the front, (b) is a view from the front, (c) is a side view from a side of a slit, (d) is a side view rotated by 90 degrees in the circumferential direction from (c), (e) is a vertical cross-sectional view taken along line E-E in (c), (f) is a perspective view from the rear, (g) is a view from the rear, and (h) is a transverse section taken along line H-H of (d).

FIG. 10 is perspective view of the cosmetic applicator according to the third embodiment, illustrating a quarter cutaway view of a part from an application portion to a front barrel.

### DESCRIPTION OF EMBODIMENTS

Embodiments of the present invention will be described below with reference to the attached drawings.

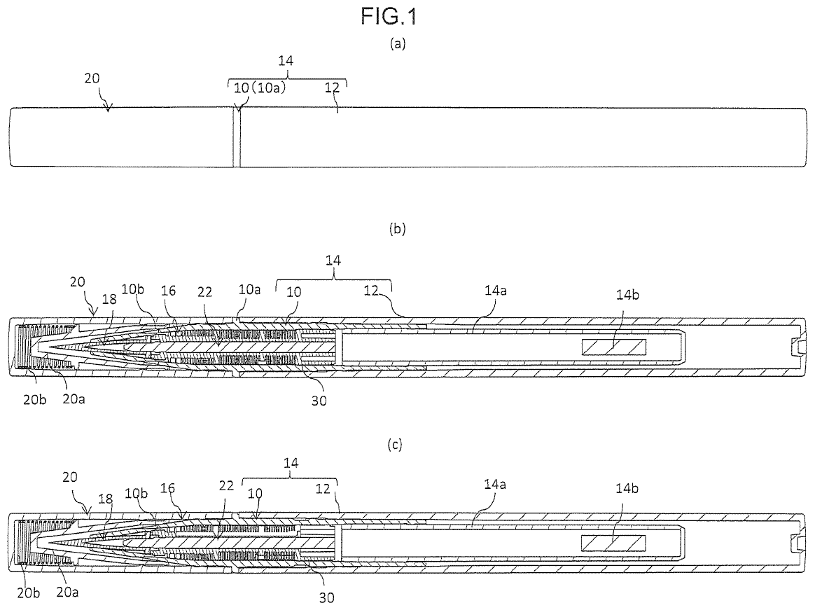

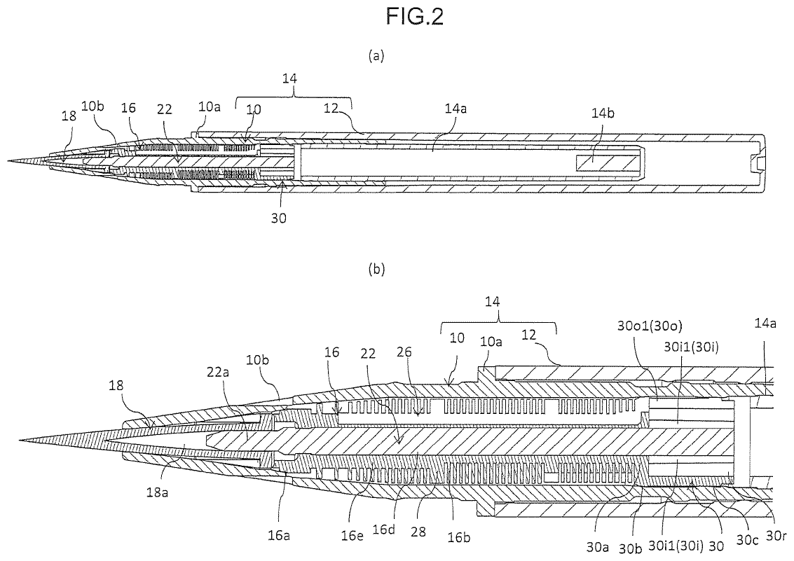

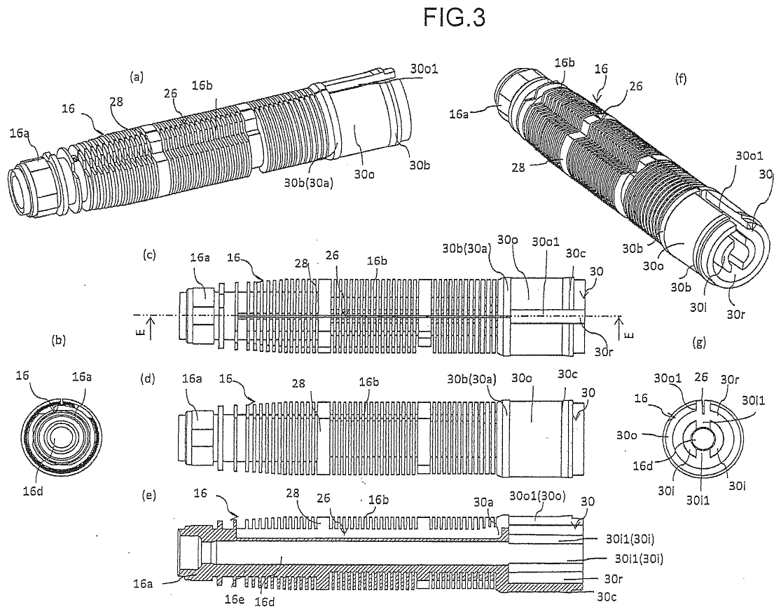

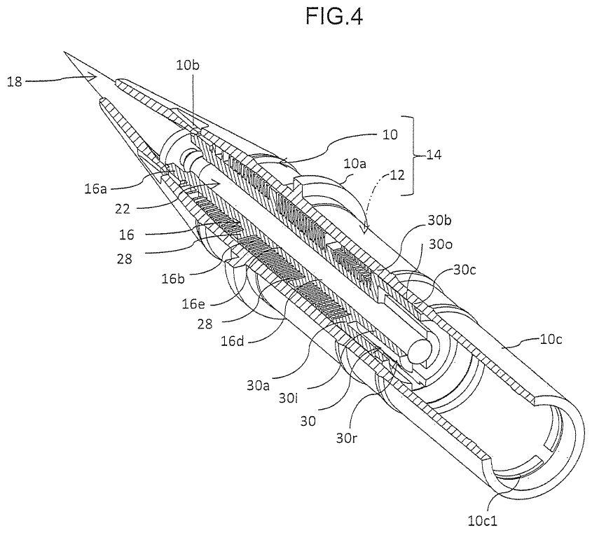

FIG. 1 is an overall explanatory diagram of a cosmetic applicator according to a first embodiment of the present invention. FIG. 2 is an explanatory diagram of the cosmetic applicator from which a cap is removed. FIG. 3 is a component diagram of a collector. FIG. 4 is an explanatory perspective view of a front portion.

### Outline of Cosmetic Applicator

As illustrated in FIGS. 1 and 2, the applicator according to the first embodiment is the cosmetic applicator that includes a barrel body 14 formed by combining a front barrel 10 and a rear barrel 12 and provided with an application body (drawing portion) 18 at a tip end thereof, a cap 20 that is attachable to and detachable from a tip end portion of the barrel body 14 and covers the application body 18, a collector (temporary retaining body) 16 of which an outer circumferential surface has a comb shape and that is mounted within the barrel body 14 (the front barrel 10), a liquid storage portion 14a disposed in an inner space of a rear portion (the rear barrel 12) of the barrel body 14 and storing a cosmetic liquid, a collector core (guide body) 22 that guides the cosmetic liquid in the liquid storage portion 14a to the application body 18, the collector 16 that temporarily retains the cosmetic liquid supplied to the application body 18, and a cosmetic liquid holding portion 30 provided in a rear portion of the collector 16. The cosmetic liquid holding portion 30 substantially has a cup shape open to the rear, and is formed by a space formed as a recess in a cross-sectional view. The gap between the inner periphery of the barrel body 14 (the front barrel 10) and the outer periphery of the collector 16 is 0.05 mm or less.

### Barrel Body 14

Specifically, in the cosmetic applicator, in the barrel body 14, the front barrel 10 and a rear portion side of the front barrel 10 are externally fitted to the rear barrel 12. The collector 16 formed in the shape of comb teeth in which a plurality of sheet portions (also referred to as fins or bellows portions) are arranged in an axial direction is disposed in the front portion of the barrel body 14. The cosmetic liquid is stored in the liquid storage portion 14a in the rear portion (the rear barrel 12) of the barrel body 14.

The front barrel 10 supporting the application body 18 is mounted to a tip part of the barrel body 14, the collector 16 is mounted in the front barrel 10 of the tip part, and the cartridge type liquid storage portion 14a is disposed in the rear barrel 12 of a rear part of the barrel body 14. The cosmetic applicator is a direct liquid type in which a cosmetic liquid is stored as a direct liquid in the liquid storage portion 14a.

### Front Barrel 10

As illustrated in FIG. 2, at an outer circumferential surface of the front barrel 10, a flange 10a is formed protruding in an outer radial direction. The flange 10a has a tapered front end portion and a center portion for positioning the cap 20 when the cap 20 is fitted to the front barrel 10. An uneven portion for fitting the cap 20 is formed in front of the flange 10a, and an uneven portion for fitting the rear barrel 12 is formed behind the flange 10a. In addition, an air replacement hole 10b penetrating the circumferential surface from the inside to the outside is formed in front of the uneven portion of the front barrel 10. The rear portion of the front barrel 10 extends and a tubular portion 10c accommodating the front portion of the liquid storage portion 14a therein extends, and a protruding portion 10c1 for engaging and fixing the liquid storage portion 14a is formed inside the tubular portion 10c (see FIG. 4). In a state where the collector 16 and the liquid storage portion 14a are mounted in the front barrel 10, an appropriate clearance is provided between the front end portion of the liquid storage portion 14a and the rear end portion of the cosmetic liquid holding portion 30 of the collector 16.

### Rear Barrel 12

The rear barrel 12 has a tubular shape with a closed rear portion. A front portion of the rear barrel 12 is fitted to the front barrel 10 to cover a rear portion of the front barrel 10 from the flange 10a of the front barrel 10. The rear barrel 12 is substantially formed into a pipe shape accommodating the liquid storage portion 14a therein, together with the rear portion of the front barrel 10.

### Liquid Storage Portion 14a

In the liquid storage portion 14a, no impregnation body such a cotton pad is provided. The cosmetic liquid is directly stored, and a stirring body (such as a columnar body and a ball) 14b used to stir the cosmetic liquid is provided. FIG. 2 illustrates an upward application state in which the stirring body 14b abuts against the rear end portion of the liquid storage portion 14a.

### Cosmetic Liquid

The cosmetic liquid contains at least carbon black, water, 0.2 to 5 mass % of a dispersant composed of a film-forming resin, 2 to 15 mass % of a film-forming agent (in terms of solid content), and 0.5 wt. % or less of a surfactant. The cosmetic liquid has a viscosity in the range of 2 to 8 mPa*s at a temperature of 25° C. and a shear rate of 192 S-1, measured by an ELD-type viscometer.

The carbon black is used as a colorant and is not particularly limited, as long as the carbon black is a carbon black normally used as a colorant for liquid cosmetics of black color, and various types of carbon black can be used.

The content of the carbon black is preferably 1 to 15 mass % and more preferably 3 to 10 mass %, relative to the total amount of the liquid cosmetic. When the content of the carbon black is less than 1 mass %, the color is developed too thinly to be sufficient as a cosmetic material. On the other hand, when the content is more than 15 mass %, the viscosity is too high and it is not possible to smoothly discharge the liquid by a liquid cosmetic applicator using a cotton pad or a collector according to the present invention, which is not preferable.

The dispersant is composed of a film-forming resin, improves the dispersibility of carbon black serving as a colorant, and also functions as a resin for forming a film.

The dispersant that may be used is not particularly limited, as long as the dispersant has the above-described functions. Examples of the dispersant include a betaine-type alkyl acid-based amphoteric resin and a copolymer composed of one or two or more components selected from acrylic acid, methacrylic acid, or alkyl esters and derivatives thereof, vinyl acetate, and vinylpyrrolidone. From the viewpoint of increasing the dispersion performance of the carbon black, the dispersant is preferably a copolymer of vinyl acetate with one component selected from acrylic acid, methacrylic acid, or alkyl esters and derivatives thereof, a copolymer of vinylpyrrolidone and vinyl acetate, and a copolymer of octylacrylamide with one or more components among acrylic acid, methacrylic acid, or alkyl esters thereof. From the viewpoint of further increasing the dispersion performance and the film forming ability, the dispersant is particularly preferably a copolymer of octylacrylamide with one or more components among acrylic acid, methacrylic acid, or alkyl esters thereof.

The content of the dispersant is preferably 0.5 to 5 mass % and more preferably 2 to 4 mass %, relative to the total amount of the liquid cosmetic.

When the content of the dispersant is less than 0.5 mass %, the dispersion stability of carbon black as a colorant is insufficient. On the other hand, when the content of the dispersant exceeds 5 mass%, the viscosity is too high and the dispersion stability does not improve, which is not economical.

Examples of the film-forming agent used in the present invention include emulsion resins of copolymers selected from one or two or more monomers among acrylic acid, methacrylic acid, or alkyl esters and derivatives thereof, styrene, and vinyl acetate.

In the present invention, the above-described dispersant is also composed of a film-forming resin. However, the film-forming agent is different from the above-described dispersant in that the film-forming agent is a soluble resin and an emulsion resin, and the emulsion resin is an aqueous suspension obtained by emulsion polymerization of a monomer in water. When dispersing the carbon black according to the present invention, a more stable dispersion liquid of carbon black is obtained by using the soluble resin than by using the emulsion resin. Thus, the soluble resin and the emulsion resin are used for different purposes.

The content of the film-forming agent (emulsion resin) is preferably 2 to 15 mass %, and more preferably 5 to 10 mass % in terms of solid content (resin content), relative to the total amount of the liquid cosmetic.

When the content of the film-forming agent (emulsion resin) is less than 2 mass % in terms of solid content (resin content), the water resisting performance is poor. On the other hand, when the content of the film-forming agent is more than 15 mass % in terms of solid content (resin content), the application portion (such as a brush and a pen core) of the liquid cosmetic applicator may dry and thus, it may not be possible to apply the liquid cosmetic, which is not preferable.

A surfactant may be used to stabilize the film-forming agent (emulsion resin). However, the content of the surfactant added to the film-forming agent is not considered here, because the surfactant has little influence on the fixability in the present invention.

The surfactant to be used in the present invention is a surfactant functioning as a dispersion aid to disperse carbon black. Examples of the surfactant include nonionic surfactants, anionic surfactants, cationic surfactants, lecithin, propylene glycol fatty acid esters, glycerin fatty acid esters, and polyglycerin fatty acid esters, and further, mixtures of one or two or more components among polyoxyethylene alkyl ethers, polyoxyethylene polyoxypropylene alkyl ethers, polyoxyethylene alkyl ether phosphates, polyethylene glycol fatty acid esters, alkyl sulfates, sulfonates, and polyoxyethylene alkyl ether sulfates.

The content of the surfactant is preferably 0.5 mass % or less, and more preferably 0 to 0.3 mass %, relative to the total amount of the liquid cosmetic.

When the content of the surfactant is more than 0.5 wt. %, the water resistance is poor and it is not possible to obtain sufficient fixing force, which is not preferable.

In the liquid cosmetic of the present invention, water (including purified water, distilled water, ion-exchanged water, pure water, ultrapure water, and the like) serves as a solvent. The content of water is the remainder excluding the above-described components and optional components described below.

Furthermore, the liquid cosmetic of the present invention may contain, in addition to the essential components and the like, optional components used in ordinary liquid cosmetics. Specifically, the liquid cosmetic may contain a preservative, an antioxidant, a neutralizing agent, an ultraviolet absorber, a chelating agent, a humectant, a beauty component, a perfume, and a viscosity modifier, in an appropriate amount that does not impair the effects of the present invention.

The liquid cosmetic of the present invention has a viscosity in the range of 2 to 8 mPa*s, and particularly preferably 3 mPa*s to 6 mPa*s, at a temperature of 25° C. and a shear rate of 192 S-1, measured by an ELD-type viscometer.

When the viscosity value is less than 2 mPa*s, the liquid flows into wrinkles or the like and causes bleeding. On the other hand, when the viscosity value exceeds 8 mPa*s, the viscosity is high, and thus, it is not possible to smoothly discharge the liquid cosmetic contained in a liquid cosmetic applicator using a brush or a pen core as the application means of the present invention, which is not preferable. Specifically, the conditions in the viscosity measurement (including in the Examples and the like described below) refer to values measured at a temperature of 25° C. and a shear rate of 192 (S-1) in an ELD-type viscometer manufactured by Tokimec Inc. using a 50 rpm standard cone rotor.

The liquid cosmetic of the present invention preferably has a surface tension of 30 to 40 mN/m. The measured surface tension refers to a value obtained at a temperature of 25° C. by using a CBVP-Z type surface tensiometer (plate method) manufactured by Kyowa Interface Science Co., Ltd.

### Material of Members

The front barrel 10, the rear barrel 12, the barrel body 14, the collector 16, the cap 20, and the like may be molded resin products. A ball material made of a metal or a resin can be used for the stirring body 14.

### Application Body 18

The application body 18 formed of a brush body having a tapered shape that becomes narrow toward the front, protrudes from an opening at the front end portion of the front barrel 10, and the cap 20 covering the application body 18 is attachably and detachably fitted to the front barrel 10. The front barrel 10 has a substantially conical side shape and is tapered, and the tip end angle of the front barrel 10 is preferably substantially the same angle as the tip end angle of the application body 18.

As illustrated in FIG. 2(b), the application body 18 has a hollow portion 18a extending from the rear end portion to the inside of the application body 18, and a tip end portion 22a of the collector core 22 is fitted into the hollow portion 18a. The tip end portion 22a of the collector core 22 fitted into the hollow portion 18a allows for the cosmetic liquid in the liquid storage portion 14a transmitted through the collector core 22, to be sufficiently supplied to the application body 18.

The application body 18 is a tapered brush body made of resin fibers, natural fiber bundles, or a porous body made of resin. The rear end portion of the application body 18 has an enlarged diameter in a flange shape. This enlarged portion is engaged with the inside of the front barrel 10 and prevents the front barrel 10 from detaching. The application body 18 is suitably a brush body, but any other application body configured to apply a cosmetic liquid can be used. Furthermore, the frontmost end portion of the application body 18 may be disposed at a position separated from the axis of the application body 18, that is, from a so-called center line, and the application body 18 may have a side ridge line connecting the frontmost end portion and an end portion positioned on the opposite side of the frontmost end portion by sandwiching the axis, and the side ridge line may be formed obliquely at a predetermined angle of less than 90 degrees, preferably 60 degrees to 80 degrees, with respect to the axis of the application body 18. With such application body 18, it is possible to draw lines from a thin line to a thick line.

### Cap 20

As illustrated in FIG. 1, when the cap 20 is externally fitted to the front barrel 10, the cap 20 covers the application body 18 to prevent drying of the application body 18. As illustrated in FIG. 2, when the cap 20 is removed, the application body 18 is exposed and the cosmetic material can be applied. A cup-shaped inner cap 20a covering the application body 18 to enhance airtightness is arranged movably to the front and rear inside the cap 20, and a spring 20b is arranged to urge the inner cap 20a toward the rear.

### Arrangement Structure in Front Barrel 10

As illustrated in FIG. 3, the collector 16 having a bellows shape in which a plurality of sheet bodies are arranged is disposed behind the application body 18 inside the front barrel 10 that has a hollow, tapered shape. The collector core (corresponding to a guide core) 22 is disposed to penetrate a hollow portion 16d of the collector 16. The collector core 22 can be formed of a capillary member such as a resin fiber bundle, a natural fiber bundle, or a porous body made of resin.

In the collector core 22, the collector core 22 does not protrude from the rear end portion of the collector 16 into the liquid storage portion 14a of the barrel body 14. A rear end surface of the collector core 22 substantially coincides with a rear end surface of the collector 16. When the collector core 22 coincides with the collector 16, the rear end of the collector core 22 does not protrude into the liquid storage portion 14a, and the volume in the liquid storage portion 14a can be secured. The rear end of the collector core 22 does not protrude into the liquid storage portion 14a, and thus, when the stirring body 14b is provided in the liquid storage portion 14a, the stirring body 14b does not contact the cosmetic liquid holding portion 30, does not collide with the collector core 22, and does not cause the collector core 22 to deform, even when the stirring body 14b moves inside the liquid storage portion 14a. Therefore, sufficient penetration of the cosmetic liquid can be achieved.

### Collector 16

The collector 16 is covered and held by the barrel body 14 formed by combining the front barrel 10 and the rear barrel 12. As illustrated in FIGS. 2 and 3, in the collector 16, a bowl-shaped portion 16a is formed at the front end portion in the axial direction. The cosmetic liquid holding portion 30 having a diameter larger than that of each temporary retaining portion 16b is formed at the rear end portion of the collector 16. In the collector 16, temporary retaining portions 16b in which a plurality of comb tooth-shaped fins (sheet bodies) are arranged with gaps in-between, are formed at a plurality of locations in a center portion between the bowl-shaped portion 16a and the cosmetic liquid holding portion 30 in the axial direction. In the collector 16, support walls 28 that are thicker than the fins of the temporary retaining portions 16b are formed between the temporary retaining portions 16b at a plurality of locations in the axial direction. As illustrated in FIG. 2, each of the temporary retaining portions 16b is formed to have a larger diameter than the bowl-shaped portion 16a, and the cosmetic liquid holding portion 30 is formed to have a larger diameter than the temporary retaining portion 16b and each of the support walls 28. The bowl-shaped portion 16a is fitted into the tapered front portion of the front barrel 10, the cosmetic liquid holding portion 30 is fitted into the rear portion of the front barrel 10, and the collector 16 is fixed in the front barrel 10.

The collector core 22 is provided within the collector 16. In the embodiment, a pipe-shaped portion 16e of a tubular wall portion having no hole is formed in the vicinity of the axial center of the collector 16, and the hollow portion 16d penetrating along the axial center of the pipe-shaped portion 16e is provided in the pipe-shaped portion 16e.

At the outer periphery of the wall portion of the pipe-shaped portion 16e in which the hollow portion 16d is provided, a plurality of thin plate-shaped fins (sheet bodies) extending in the outer radial direction are arranged in the shape of comb teeth to form the temporary retaining portion 16b having a function of temporarily retaining the cosmetic liquid between the fins.

In the vicinity of the axial center portion inside the collector 16, the collector core 22 through which the cosmetic liquid flows is mounted to the hollow portion 16d inside the pipe-shaped portion 16e. The fins (the temporary retaining portions 16b) shaped as comb teeth forming a plurality of comb teeth are provided at the outer periphery of the pipe-shaped portion 16e, and the pipe-shaped portion 16e is shaped as a wall without holes in which no hole penetrating the wall is formed from the inner periphery to the outer periphery.

The tip end portion 22a of the collector core 22 is fitted into the hollow portion 18a of the application body 18. The cosmetic liquid in the liquid storage portion 14a is guided via the collector core 22 inserted into the pipe-shaped portion 16e in the collector 16.

In the collector 16, a slit 26 serving as a longitudinal groove guiding the cosmetic liquid into the gaps between the fins is formed from the temporary retaining portion 16b to the cosmetic liquid holding portion 30 and is exposed at the rear end portion (to be exposed toward the liquid storage portion 14a). Furthermore, each of the thick support walls 28 that abut against the inner surface of the front barrel 10 is provided between every several fins in the temporary retaining portion 16b, appropriately partitioning the fins. Specifically, the number of fins of the temporary retaining portion 16b may be 40 to 60 in total, and the gap between the fins may be 0.15 to 0.3 mm.

The storable amount in the liquid storage portion 14a is 0.7 (ml). The outer diameter of the barrel body 14 is 8.5 (mm) and the diameter of the collector 16 is 6.0 (mm).

### Cosmetic Liquid Holding Portion 30

The collector core does not protrude into the liquid storage portion 14a from the cosmetic liquid holding portion 30 at the rear end portion of the collector 16. However, a space 30r in the cosmetic liquid holding portion 30 faces the opening tip end of the liquid storage portion 14a, and the cosmetic liquid can be sufficiently supplied to the cosmetic liquid holding portion 30 and the collector core 22.

An outer circumferential surface (a protruding portion 30b) of the cosmetic liquid holding portion 30 provided at the rear portion of the collector 16 contacts the inner wall surface of the front barrel 10 in a liquid-tight manner.

Specifically, a sealing portion (the protruding portion 30b) for sealing between the cosmetic liquid holding portion 30 and the front barrel 10 (a barrel tube 14) is provided on the outer circumferential surface of the front end portion of the cosmetic liquid holding portion 30, and a fitting portion 30c for preventing detachment from the front barrel 10 (the barrel tube 14) is formed on the outer circumferential surface of the rear end portion of the cosmetic liquid holding portion 30. The cosmetic liquid holding portion 30 at the rear end portion of the collector 16 is fitted into the inner surface of the front barrel 10 and thus, the collector 16 is fixed to the front barrel 10.

Specifically, as illustrated in FIG. 2(b), 3, and 4, the cosmetic liquid holding portion 30 is formed continuously with the rear end portions of the temporary retaining portion 16b and the pipe-shaped portion 16e. Specifically, the cosmetic liquid holding portion 30 includes a wall-shaped base portion 30a formed at the rear end of the pipe-shaped portion 16e and having a diameter increasing in a disc shape, and an outer wall portion 30o and an inner wall portion 30i each extending rearward from the base portion 30a and having a concentric and substantially tubular shape.

It is preferable that the outer wall portion 30o and the inner wall portion 30i have a substantially cup-like shape, the space 30r is formed between the outer wall portion 30o and the inner wall portion 30i, the space 30r has a function of holding a cosmetic liquid, and the holding amount of the cosmetic liquid is 20 to 40 mg.

The outer wall portion 30o and the inner wall portion 30i are formed with an opening groove 30o1 and an opening groove 30i1, respectively, which expand the space 30r. The opening groove 3001 of the outer wall portion 30o is formed at one position along the axial direction on the same side as the slit 26 and continuously with the slit 26.

The protruding portion 30b formed in an annular rib shape and serving as a sealing portion for maintaining liquid tightness when the liquid holding portion 30 is fitted to the inner circumferential surface of the front barrel 10 (the barrel body 14), is formed on the outer circumferential surface of the front end portion of the outer wall portion 30o of the cosmetic liquid holding portion 30, to protrude in the outer shape direction near the outer periphery of the base portion 30a. A fitting portion 30c for preventing the cosmetic liquid holding portion 30 from detaching from the front barrel 10 is formed on an outer circumferential surface of a rear end portion of the outer wall portion 30o.

The opening groove 30i1 is formed at two locations of the inner wall portion 30i, that is, on the same side as the slit 26 and the opposite side of the slit 26. The inner diameter of the inner wall portion 30is such that the rear end portion of the collector core 22 can be tightly attached thereto. For example, the inner diameter of the inner wall portion 30i can be the same as the inner diameter of the hollow portion 16d in the pipe-shaped portion 16e.

The cosmetic applicator according to the embodiment is a collector-type applicator. In the cosmetic applicator, when a tip end side of the application body 18 is directed downward, the cosmetic liquid flows into the cosmetic liquid holding portion 30. As illustrated in FIG. 2, when the side of the application body 18 of the cosmetic applicator is directed upward, the cosmetic liquid contained in the cosmetic liquid holding portion 30 is held by the surface tension of the contained liquid without dropping downward.

Therefore, when the brush dries during upward drawing or storage, the cosmetic liquid held in the space 30r of the cosmetic liquid holding portion 30 is supplied to a relay core (collector core 22) via the opening grooves 30i1 and 30o1.

Here, when a member such as a porous body is provided in the liquid holding portion and a liquid is used that has low surface tension, the contact area between the cosmetic liquid and the liquid holding portion is small, the holding force may be too weak to hold the liquid and, depending on the member, not enough liquid may be supplied to the application portion. However, in the embodiment, the inner walls (inner wall portions 30i) are provided, and thus, it is possible to increase the contact area between the cosmetic liquid and the cosmetic liquid holding portion 30, and it is possible to easily hold even a liquid having low surface tension.

### Example 1

### Collector 16

Ratio: front side (temporary retaining portion 16b) 80%, rear side (cosmetic liquid holding portion 30) 20% (when liquid holding amount is 30 mg)

A cosmetic liquid having the composition described below was used in the cosmetic applicator in accordance with the configuration below and FIGS. 1 to 4.

### Configuration of Front Barrel 10

Made of polypropylene, length: 50 mm, length of tapered front end portion: 15 mm, diameter of tip end side opening portion: 2 mm, diameter of rear end side opening portion: 6 mm
Configuration of Rear Barrel 12, Stirring Body 14b, Collector 16, and Collector Core 22
Rear barrel 12: made of polypropylene resin, outer diameter: 10 mm, length: 90 mm
Stirring body 14b: weight: 0.40 g, made of stainless steel, shape: cylindrical shape, φ2.5 mm×length 10 mm
Collector 16: The total number of fins in the temporary retaining portion 16b was 47, the ratio in the temporary retaining portion 16b was 80%, the ratio in the cosmetic liquid holding portion 30 was 20% (when the liquid holding amount was 30 mg), and the gap between the fins was 0.15 to 0.3 mm.
Amount storable in liquid storage portion 14a: 0.7 (ml), outer diameter of liquid storage portion 14a: 8.5 (mm), inner diameter: 4.5 (mm), outer diameter of collector 16: 6.0 (mm).
Collector core 22: porous body made of polyester, porosity 60%, diameter 2 mm×length 35 mm

### Configuration of Application Body 18

Polybutylene terephthalate resin fibers were used as a raw material, and the application body 18 being used was composed of about 300 to 350 fibers having a length of 15 mm and a diameter of 100 μm and a flange portion having a diameter of 5 mm.

### Composition of Cosmetic Liquid (Black) Used in Test

Carbon black: 8%
Alkyl acrylate copolymer emulsion: 20%
   Yodosol GH800F (glass-transition point: −15° C., solid content: 45%, manufactured by Nouryon Japan)
Acrylic acid octylamide/acrylic acid ester copolymer: 1.2%
   AMPHOMER HC (solid content 100%, manufactured by Nouryon Japan)
Polyethylene glycol alkyl ether: 0.2%
Diethylhexyl Na sulfosuccinate solution: 0.1%
Ethylhexylglycerin: 0.2%
Disodium edetate: 0.3%
1,3-Butylene glycol: 10%
Methylparaben: 0.3%
Sodium dehydroacetate: 0.3%
Aminomethyl propanol: 0.1%
Purified water: remainder

### Physical Properties of Cosmetic Liquid (Black) Used in Test

Viscosity at shear rate 192 (s-1): 4 mPa*s
Surface tension: 35 mN/m
Specific gravity: 1.05

### Test for Measuring Upward Applicable Amount

### Forced Fading Test

The cosmetic applicator was heated in an atmosphere of 60° C. for 45 minutes with the brush side facing upward. Subsequently, the applicator was removed and sufficiently cooled in a room temperature environment while facing upward. Afterwards, the state was evaluated when the applicator was used facing upward to apply a cosmetic liquid. The number of samples used in the evaluation was n=3. The samples were divided into samples obtained by using an applicator including the cosmetic liquid holding portion and an applicator not including the cosmetic liquid holding portion to measure and compare the samples.

### Method of Determining Results in Forced Fading Test

A state in which drawn lines recover from fading until ten lines of a drawing line length of 30 mm are drawn is defined as A, and a state in which drawn lines do not recover from fading is defined as B. In the present evaluation, A is superior to B.

### Results in Forced Fading Test

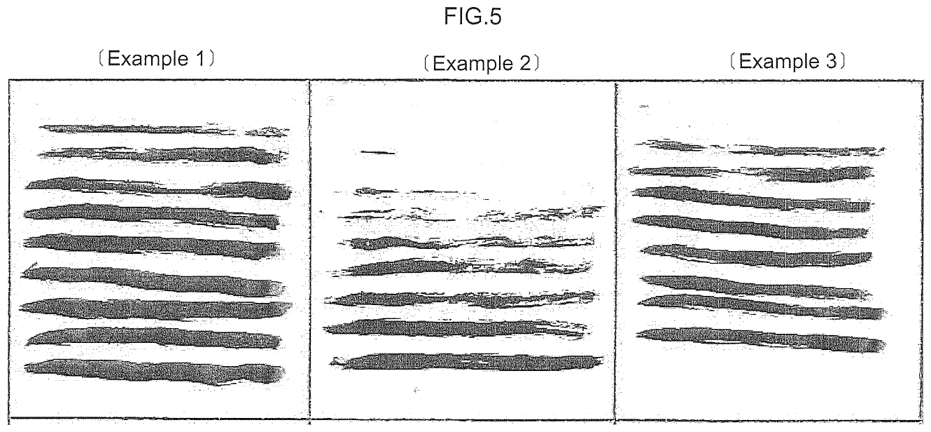

A case in which the cosmetic liquid holding portion is provided (see FIG. 5) is represented by Example 1, Example 2, and Example 3, in the order from the left frame of FIG. 5, and all of Example 1, Example 2, and Example 3 are evaluated as A.

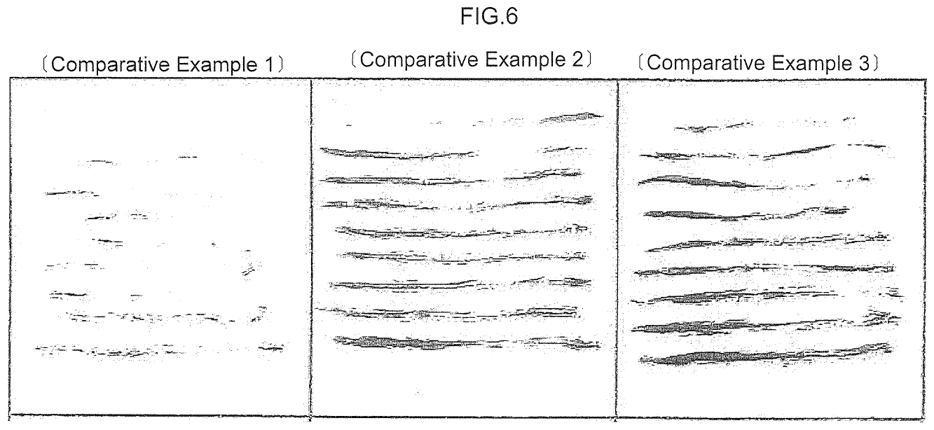

A case in which the cosmetic liquid holding portion is not provided (see FIG. 6) is represented by Comparative Example 1, Comparative Example 2, and Comparative Example 3, and all of Comparative Example 1, Comparative Example 2, and Comparative Example 3 are evaluated as B.

Cosmetic Liquid Holding Amount of Samples in Results of Forced Fading

### Test Described Above

Case in which cosmetic liquid holding portion is provided
Example 1: 40.1 mg
Example 2: 20.2 mg
Example 3: 30.3 mg

Case in which cosmetic liquid holding portion is not provided
Comparative Example 1: 9.1 mg
Comparative Example 2: 8.7 mg
Comparative Example 3: 8.2 mg

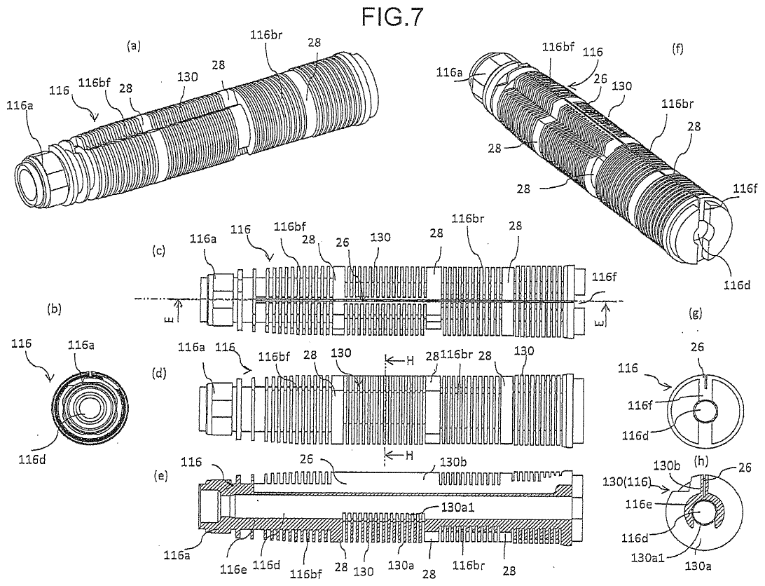

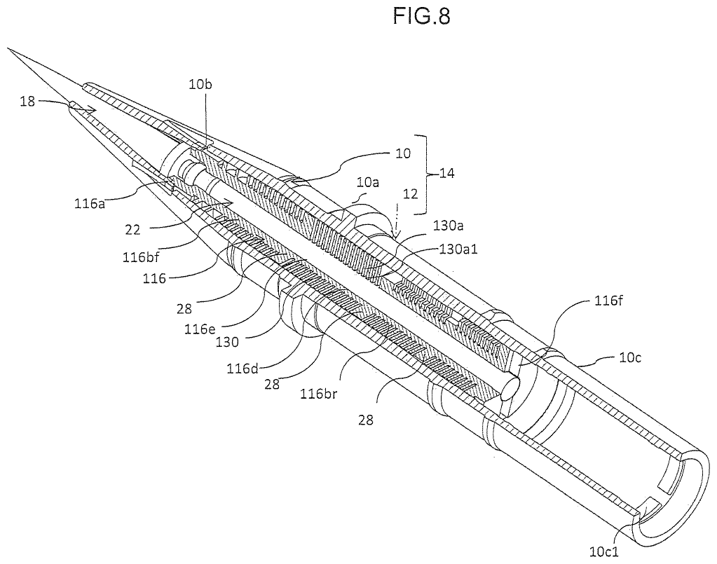

Next, a cosmetic applicator according to a second embodiment will be described. FIG. 7 illustrates a collector according to the second embodiment. FIG. 8 illustrates a quarter cutaway view of a part from an application portion to a front barrel of the cosmetic applicator. Portions similar to those in FIGS. 1 to 4 are denoted by the same reference numerals. FIG. 8 illustrates the cosmetic applicator, similarly to FIG. 4. The rear barrel 12, the liquid storage portion 14a, the stirring body 14b, and the like are not illustrated. However, the omitted portions have similar configurations as in the first embodiment.

The cosmetic applicator according to the second embodiment includes a collector 116 and a cosmetic liquid holding portion 130 having structures different from the collector 16 and the cosmetic liquid holding portion 30 of the first embodiment illustrated in FIGS. 1 to 4. As illustrated in FIG. 8, the cosmetic liquid holding portion 130 is capable of holding the cosmetic liquid in spaces 130a between a plurality of sheet bodies provided in a stacked manner at a center portion in a length direction of the collector 116, and each of the spaces 130a provided between the sheet bodies contacts the collector core 22 via a communication hole 130a1.

### Arrangement Structure of Collector 116

As illustrated in FIG. 8, the collector 116 having a bellows shape in which the plurality of sheet bodies are arranged is disposed behind the application body 18 inside the front barrel 10 that has a hollow, tapered shape. The collector core (corresponding to a guide core) 22 is disposed to penetrate a hollow portion 116d of the collector 116. The collector core 22 can be formed of a capillary member such as a resin fiber bundle, a natural fiber bundle, or a porous body made of resin.

In the collector core 22, the collector core 22 does not protrude from the rear end portion of the collector 116 into the liquid storage portion (not illustrated) of the barrel body 14. A rear end surface of the collector core 22 substantially coincides with (is flush with) a rear end surface of the collector 116. When the rear end surface of the collector core 22 coincides with the collector 116, the rear end of the collector core 22 does not protrude into the liquid storage portion, and the volume in the liquid storage portion can be secured. The rear end of the collector core 22 does not protrude into the liquid storage portion, and thus, when the stirring body (not illustrated) is provided in the liquid storage portion, the stirring body contact the rear end surface of the collector 116, does not collide with the collector core 22, and does not cause the collector core 22 to deform, even when the stirring body moves inside the liquid storage portion. Therefore, sufficient penetration of the cosmetic liquid can be achieved.

### Collector 116

As illustrated in FIG. 8, the collector 116 is structured to be covered and held by a barrel body 14 formed by combining the front barrel 10 and the rear barrel 12.

As illustrated in FIG. 7, a bowl-shaped portion 116a is formed at the front end portion of the collector 116 in the axial direction. In the collector 116, a collector body is provided behind the bowl-shaped portion 116a. The collector body includes, in this order, a temporary retaining portion 116bf in a front portion, a cosmetic liquid holding portion 130 in a center portion, and a temporary retaining portion 116br in a rear portion, which are connected to each other. The collector body as a whole is formed to have a slightly larger diameter than the bowl-shaped portion 116a.

A recessed portion (groove portion) 116f is formed on a rear end surface of the collector 116 facing the side of the liquid storage portion. As illustrated in FIG. 8, the rear end portion of the collector core 22 protrudes into the recessed portion 116f and thus, the cosmetic liquid easily flows to the rear portion of the collector core 22 via the recessed portion 116f. However, the rear end portion of the collector core 22 does not protrude from the rear end surface of the collector 116 and thus, the stirring body in the liquid storage portion does not contact the collector core 22. The rear end portion of the slit 26 also faces the inside of the recessed portion 116f (see FIG. 7), and the stirring body does not contact the slit 26. The slit 26 is a fine gap formed with high accuracy, and thus, the accuracy can be surely maintained by preventing the stirring body from contacting the slit 26.

The temporary retaining portion 116bf in the front portion of the collector 116 and the temporary retaining portion 116br in the rear portion of the collector 116 are formed in a structure in which a plurality of fins (sheet bodies) shaped as comb teeth are arranged with gaps there between.

The cosmetic liquid holding portion 130 is formed in a structure in which pluralities of thin plate-shaped fins (sheet bodies) are arranged in the shape of comb teeth with gaps there between.

In the second embodiment, a pipe-shaped portion 116e having a tubular shape is formed in the vicinity of the axial center of the collector 16, and the hollow portion 116d penetrating along the axial center of the pipe-shaped portion 116e is provided in the pipe-shaped portion 116e. The collector core 22 is inserted into and arranged in the hollow portion 116d.

The cosmetic liquid holding portion 130 is formed with a plurality of fins (sheet bodies) each forming a thin plate shape on the outer periphery of the wall portion of the pipe-shaped portion 116e. In a part of the pipe-shaped portion 116e where the cosmetic liquid holding portion 130 is formed, a plurality of fins (sheet bodies) are exposed to the inside of the hollow portion 116d, and the communication hole 130al is formed and bored, through which the space 130a between the fins communicates with the inside of the hollow portion 116d. The communication hole 130a1 is bored to have a length in the circumferential direction of 0.15 mm to ⅓ of the entire circumference, in consideration of the circulation properties of the liquid.

Accordingly, the collector core 22 disposed in the hollow portion 116d contacts the space 130a between the fins of the cosmetic liquid holding portion 130 via the communication hole 130a1. Therefore, in the cosmetic liquid holding portion 130, the cosmetic liquid held (retained) in the space 130a contacts the collector core 22 and flows to the collector core 22 via the communication hole 130a1.

In the collector 116, at the outer periphery of the wall portion of the pipe-shaped portion 116e where the hollow portion 116d is provided, in front and behind the cosmetic liquid holding portion 130, the temporary retaining portions 116bf and 116br are arranged in the shape of comb teeth as a plurality of thin plate-like fins (sheet bodies) extending in the outer diameter direction. The fins have a function of temporarily retaining the cosmetic liquid between the fins via the slit 26. In the pipe-shaped portion 116e, no holes are formed at the arrangement locations of the temporary retaining portions 116bf and 116br, and the temporary retaining portions 116bf and 116br are provided separately and independently from the hollow portion 116d. As illustrated in FIG. 7(e), the cosmetic liquid on the side of the liquid storage portion 14a flows only through the slit 26 that extends longitudinally through the temporary retaining portions 116bf and 116br.

As illustrated in FIG. 7(e) and 7(h), in the collector 116, a location where the slit 26 is formed at the same position in the axial direction as the location where the cosmetic liquid holding portion 130 is formed, is a portion (solid portion) 130b where the space 130a between the fins of the cosmetic liquid holding portion 130 does not exist. The communication hole 130al is not formed in the portion 130b, and thus, the portion 130b is partitioned by the pipe-shaped portion 116e and does not communicate with the hollow portion 116d.

Accordingly, the portion (solid portion) 130b is provided in which the space 130a is not formed. Therefore, the slit 26 does not communicate with the space 130a of the cosmetic liquid holding portion 130, and the cosmetic liquid on the side of the liquid storage portion does not flow to the cosmetic liquid holding portion 130 via the slit 26.

In the collector 116, the support walls 28 that are thicker than the fins of the temporary retaining portions 116bf and 116br are formed between the temporary retaining portion 116bf in the front portion of the collector 116 in the axial direction, the cosmetic liquid holding portion 130, and the temporary retaining portion 116br in the rear portion of the collector 116.

The number of fins in the temporary retaining portion 116bf in the front portion and the temporary retaining portion 116br in the rear portion may be 40 to 60 in total, and the gap between the fins may be 0.15 to 0.3 mm. The gap between the fins in the space 130a of the cosmetic liquid holding portion 130 is 0.15 mm to 0.30 mm, which is the same as the gap between the temporary retaining portion 116bf in the front portion and the temporary retaining portion 116br in the rear portion.

According to the liquid cosmetic applicator of the second embodiment, the cosmetic liquid holding portion 130 holds the cosmetic liquid by capillary force in the space 130a between the sheet bodies provided in the collector 116. Therefore, the cosmetic liquid can be held more reliably than by the cosmetic liquid holding portion of the first embodiment in which a recessed portion is formed at the rear end.

When the side of the application body 18 (application portion) of the liquid cosmetic applicator is directed upward, the cosmetic liquid is held without dropping downward, by the surface tension of the contained liquid contained in the cosmetic liquid holding portion 130 and the liquid holding ability of the collector. When the application body dries during upward drawing or storage, the cosmetic liquid held in the cosmetic liquid holding portion 130 is supplied from the opening groove (the communication hole 130a1).

The cosmetic liquid holding portion 30 of the first embodiment is formed in a hollow shape as the recessed portion (the space 30r) at the rear end, as illustrated in FIG. 2 and the like. However, when the recessed portion is used, the contact area between the cosmetic liquid and the holding portion is small, and in the case of a liquid having a low surface tension, the holding force may be weak and it may be difficult to hold the liquid. However, in the second embodiment, the liquid can be held in the space 130a between the sheet bodies of the cosmetic liquid holding portion 130 formed in the collector 116, and thus, the holding force is improved by capillary force.

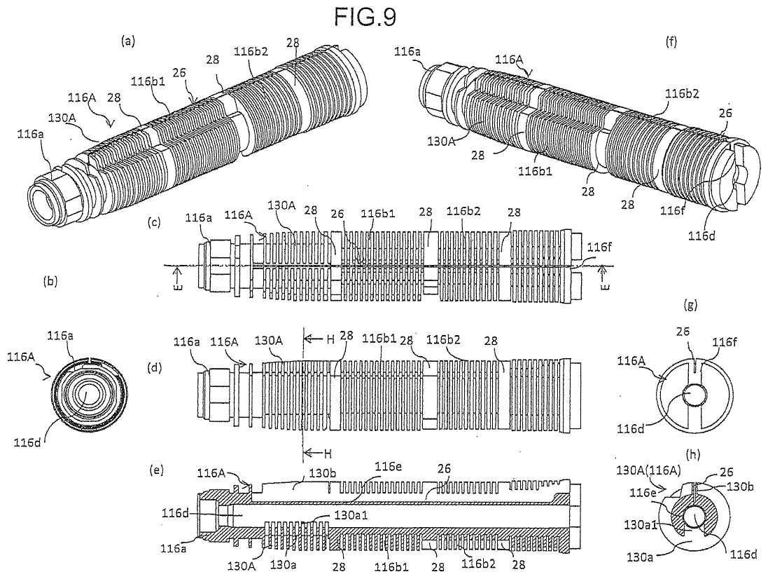

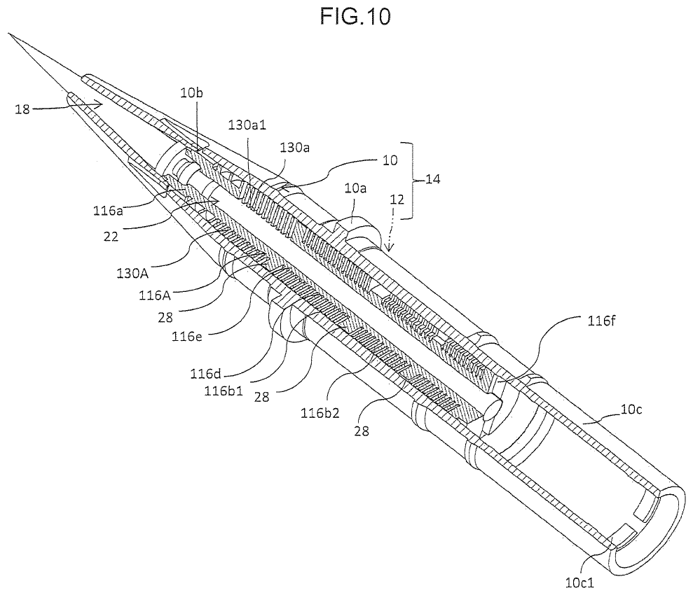

Next, a cosmetic applicator according to a third embodiment will be described. FIG. 9 illustrates the collector, and FIG. 10 illustrates an overall configuration of the cosmetic applicator. Portions similar to those in FIGS. 1 to 4 are denoted by the same reference numerals.

The cosmetic applicator according to the third embodiment includes a collector 116A and a cosmetic liquid holding portion 130A having structures different from the collector 116 and the cosmetic liquid holding portion 130 of the second embodiment illustrated in FIGS. 7 and 8. Portions similar to those of the second embodiment are denoted by the same reference numerals.

As illustrated in FIGS. 9 and 10, the cosmetic liquid holding portion 130A is provided at a front portion of the collector 116A. The cosmetic liquid holding portion 130A is capable of holding the cosmetic liquid in the spaces 130a between a plurality of sheet bodies provided in a stacked manner, and each of the spaces 130a provided between the sheet bodies contacts the collector core 22 via the communication hole 130a1. As illustrated in FIG. 9(e) and (h), in the collector 116A, a location where the slit 26 is formed at the same position in the axial direction as the location where the cosmetic liquid holding portion 130A is formed, is the portion 130b where the space 130a between the fins of the cosmetic liquid holding portion 130A does not exist. The communication hole 130a1 is not formed in the portion 130b, and thus, the portion 130b is partitioned by the pipe-shaped portion 116e and does not communicate with the hollow portion 116d.

Accordingly, the portion 130b is provided in which the space 130a is not formed. Therefore, the slit 26 does not communicate with the space 130a of the cosmetic liquid holding portion 130, and the cosmetic liquid on the side of the liquid storage portion does not flow to the cosmetic liquid holding portion 130A via the slit 26.

At two positions behind the cosmetic liquid holding portion 130A in the outer periphery of the wall portion of the pipe-shaped portion 116e where the hollow portion 116d is formed, temporary retaining portions 116b1 and 116b2 are arranged in the shape of comb teeth as a plurality of thin plate-like fins (sheet bodies) extending in the outer diameter direction.

The functions of the cosmetic liquid holding portion 130A and the temporary retaining portions 116b1 and 116b2 are similar to those of the cosmetic liquid holding portion 130 and the temporary retaining portions 116bf and 116br of the second embodiment.

However, the cosmetic liquid holding portion 130A is provided at a position near the application body 18. Thus, when the application body 18 is dry or the like, the application body 18 is quickly prevented from drying via the collector core 22.

Other structures, operations, and effects are similar to those of the second embodiment.

The embodiments and Examples describe preferred examples of the present invention. However, needless to say, the present invention is not limited to the embodiments and Examples, and various modifications can be implemented within the scope of the present invention.

### Industrial Applicability

The cosmetic applicator of the present invention can be utilized in various modes of application, particularly in upward application.

### REFERENCE SIGNS LIST

10 Front barrel
10a Flange
10b Air replacement hole
12 Rear barrel
14 Barrel body
14a Liquid storage portion
14b Stirring body
16 Collector
16a Bowl-shaped portion
16b Temporary retaining portion
16d Hollow portion
16e Pipe-shaped portion
18 Application body
18a Hollow portion
20 Cap
20a Inner cap
20b Spring
22 Collector core
22a Tip end portion
26 Slit
28 Support wall
30 Cosmetic liquid holding portion
30a Base portion
30b Protruding portion
30c Fitting portion
30i Inner wall portion
30i1 Opening groove
30o Outer wall portion
30o1 Opening groove
30r Space
130 Cosmetic liquid holding portion (second embodiment)
130a Space
130a1 Communication hole
130A Cosmetic liquid holding portion (third embodiment)

1. A cosmetic applicator, comprising:
a collector core configured to guide a cosmetic liquid from a liquid storage portion to an application portion;
a collector configured to temporarily retain the cosmetic liquid, the collector being penetrated by the collector core; and
a cosmetic liquid holding portion provided in the collector, wherein
the cosmetic liquid holding portion is formed with a space configured to hold the cosmetic liquid, and the cosmetic liquid held in the cosmetic liquid holding portion contacts the collector core.

2. The cosmetic applicator according to claim 1, wherein the cosmetic liquid holding portion includes a space formed as a recess in a cross-sectional view, and the space formed as a recess in a cross-sectional view is configured to hold the cosmetic liquid, is formed in a rear portion of the collector, and contacts the collector core.

3. The cosmetic applicator according to claim 1, wherein the cosmetic liquid holding portion is configured to hold the cosmetic liquid in a space between sheet bodies provided at a front portion or a center portion of the collector, and the space between the sheet bodies contacts the collector core.

4. The cosmetic applicator according to claim 2, wherein the cosmetic liquid holding portion is integrally formed with the collector.

5. The cosmetic applicator according to claim 3, wherein the cosmetic liquid holding portion is integrally formed with the collector.
